(19) United States
(12) Patent Application Publication
(10) Pub. No.: US 2002/0009088 A1
(43) Pub. Date: Jan. 24, 2002

(54) Systems and methods for negotiating virtual circuit paths in packet switched networks

(76) Inventors: Robert J. Donaghey, Lexington, MA (US); Norman Rehn, Newbury, MA (US)

Correspondence Address: Leonard Charles Suchyta, Verizon Services Group, HQE03 H01, 600 Hidden Ridge, Irving, TX, 75038, US

(21) Appl. No.: 09/725,939

(22) Filed: Nov. 30, 2000

Related U.S. Application Data
(60) Provisional application No. 60/167,918, filed on Nov. 30, 1999.

(51) Int. Cl. H04L 12/28

(52) U.S. Cl. 370/397; 370/229

(57) ABSTRACT

A router includes at one network interface (230, 235, 240, 245) and a processor (220). Each network interface (230, 235, 240, 245) connects to at least one link. The link(s) further connect to at least one node of multiple nodes in a network. Each network interface (230, 235, 240, 245) further receives link state information. The link state information includes link data rate information. The processor (220) determines whether the link data rate information indicates if the links interconnecting the nodes satisfy a threshold data rate, and assigns virtual circuit identifiers to nodes in the network based on whether the link data rate information indicates that the links satisfy the threshold data rate.

### FIELD OF THE INVENTION

The present invention relates generally to packet switching systems and methods and, more particularly, to systems and methods for the routing of IP traffic over connection-oriented packet switches using virtual circuits in mobile, ad hoc, networks.

### BACKGROUND OF THE INVENTION

Connection-oriented protocols have conventionally been used for switching packets from a source node to a destination node in packet switching networks. Such networks have found acceptance in the mobile arena with network hardware installed in trucks and other vehicles or hand-carried. Connections between switches in such environments are often short-lived as equipment is moved together or apart, and have widely fluctuating throughput quality. The challenge of routing is substantially greater than that of stationary systems.

Connection-oriented designs for such systems have been favored because of the need to support telephony as well as machine-to-machine communications. However, Internet Protocol (IP) has become the protocol of choice for end users of such systems, so the need to route IP packets across mobile, ad hoc switching networks has been met by adding IP routers on top of the connection-oriented switches, and developing protocols for establishing the optimal path from one router to another. The algorithms used by routers to convey connectivity in a mobile network must be able to keep up with the constantly changing topology, and, as the IP addresses themselves will not convey any topological information when a router can move about freely, they typically use flooding techniques (sometimes called ‘Shortest Path First’ algorithms) to pass local connectivity information on to more distantly connected routers. A router then uses this information when sending or forwarding packets to another router to decide which way to send the packet.

Typically a router will determine which of its nearest neighbors is ‘closest’ to the destination, and then forwards the packet one hop to the chosen neighbor. To do so when the router is attached to a connection-oriented switch, as is the case here, the router must select a virtual circuit in which to place the packet. To facilitate this, it is the current practice for each switch to automatically set up a permanent one-hop circuit to each of its immediate neighbors, with the neighbor forwarding all packets arriving on this circuit to its connected IP router.

The use of multi-hop circuits for faster IP packet transport has faced a number of substantial obstacles: portable equipment lags the stationary world in terms of size and speed, and mobile switch equipment usually has sufficient memory only for small Virtual Circuit (VC) tables. Hence, circuits have to be used selectively. The paths between switches are in constant flux in a fast moving mobile environment (as, for example, in military or fire-fighting environments), so connections are constantly being broken and re-established. IP is not connection-oriented, so setting up connections as packets arrive for some new destination has proved infeasible since the standard protocols for negotiating a virtual circuit across multiple hops take substantially longer than TCP timeouts tolerate.

Knowledge of breaks in connectivity is known first to the routers closest to the break, so packets forwarded by more distant routers will often arrive with the expectation of a (now-broken) path to the destination, and the receiving router must be able to acquire control of the packet, rather than have its connected switch forward the packet further down a no-longer-complete virtual circuit. Nevertheless, fast communications is a must in ad hoc networks, and there is a need for better integration of the capabilities of the underlying connection-oriented switching network and their connected IP routers.

Therefore, there exists a need for a system and method that can implement multi-hop virtual circuit paths in a mobile, ad hoc, connection-oriented packet switching network to support fast and reliable connectivity of IP routers.

### SUMMARY OF THE INVENTION

Systems and methods consistent with the present invention address this and other needs by implementing a peer-to-peer process at each router in the network that permits the negotiation, establishment, and repair of virtual circuits across the packet-switch network through which IP packets can be tunneled, while giving each router-in-the-middle the control it needs to assure that packets flowing through its switch follow an optimum path from source to destination as routers disconnect and relocate within the network, and as link data rates fluctuate.

The exemplary processes of the present invention permit each router in the network to control the setup of its switch's virtual circuit tables according to peer-to-peer negotiations with its nearest neighbors, eliminating the need for, and avoiding the rigidity and latency of, connection request messages for establishing virtual paths to other routers in the network. The result is the establishment and maintenance of dynamically changing paths between all pairs of routers for which the connection is deemed critical enough, where this determination is based partly on the link data rates of the network and partly on the capacities of the switches' virtual circuit tables. The need for the fast end-to-end transport of packets can only be met when all contributors to latency are at a minimum. Hence when VC table size is a limiting resource, the routers set priorities for establishing fast virtual circuit paths between the routers with the highest end-to-end data throughput rates.

In accordance with the purpose of the invention as embodied and broadly described herein, a method of assigning virtual circuit identifiers for routing data in a network comprising a plurality of nodes interconnected by links of different data rates includes receiving link state information at a first node of the plurality of nodes, the link state information comprising link data rate information; determining whether the link data rate information indicates if the links interconnecting the plurality of nodes satisfy a threshold data rate; and assigning virtual circuit identifiers to nodes in the network based on whether the link data rate information indicates that the links satisfy the threshold data rate.

In another implementation consistent with the present invention, a method of routing data in an ad-hoc network including a plurality of nodes interconnected by links of different data rates includes receiving link state information at a first node of the plurality of nodes, the link state information comprising link data rate information; determining whether the link data rate information indicates if the links interconnecting the plurality of nodes satisfy a threshold data rate; assigning virtual circuit identifiers to nodes in the network based on whether the link data rate information indicates that the links satisfy the threshold data rate; and routing data received at the first node using the assigned virtual circuit identifiers.

### BRIEF DESCRIPTION OF THE DRAWINGS

The accompanying drawings, which are incorporated in and constitute a part of this specification, illustrate an embodiment of the invention and, together with the description, explain the invention. In the drawings,

FIG. 1 illustrates an exemplary network in which systems and methods, consistent with the present invention, may be implemented;

FIG. 2 illustrates exemplary components of a switch and router consistent with the present invention;

FIG. 3 is an exemplary router database consistent with the present invention;

FIG. 4 is an exemplary outgoing VCI table for storing neighbors' VC table entry assignments consistent with the present invention;

FIG. 5 is an exemplary incoming VC entry assignment table for storing the router's assignments of its switch's VC table entries consistent with the present invention;

FIG. 6 is an exemplary router VC table consistent with the present invention;

FIG. 7 is an exemplary Internet Protocol (IP) forwarding table consistent with the present invention;

FIG. 8 is an exemplary flood-tag update packet consistent with the present invention;

FIG. 9 is an exemplary neighbor-tag update packet consistent with the present invention;

FIGS. 10-13 are flowcharts that illustrate exemplary flood-tag update processing consistent with the present invention;

FIG. 14 is a flowchart that illustrates exemplary neighbor-tag update processing consistent with the present invention; and

FIG. 15 is a flowchart that illustrates exemplary packet-switch forwarding processing consistent with the present invention.

### DETAILED DESCRIPTION

The following detailed description of the invention refers to the accompanying drawings. The same reference numbers in different drawings identify the same or similar elements. Also, the following detailed description does not limit the invention. Instead, the scope of the invention is defined by the appended claims.

Systems and methods consistent with the present invention provide mechanisms that permit the negotiation, establishment, and repair of virtual circuits across a packet-switched network through which IP packets can be tunneled, while giving each router-in-the-middle the control it needs to assure that packets flowing through its switch follow an optimum path from source to destination as routers disconnect and relocate within the network, and as link data rates fluctuate.

### EXEMPLARY NETWORK

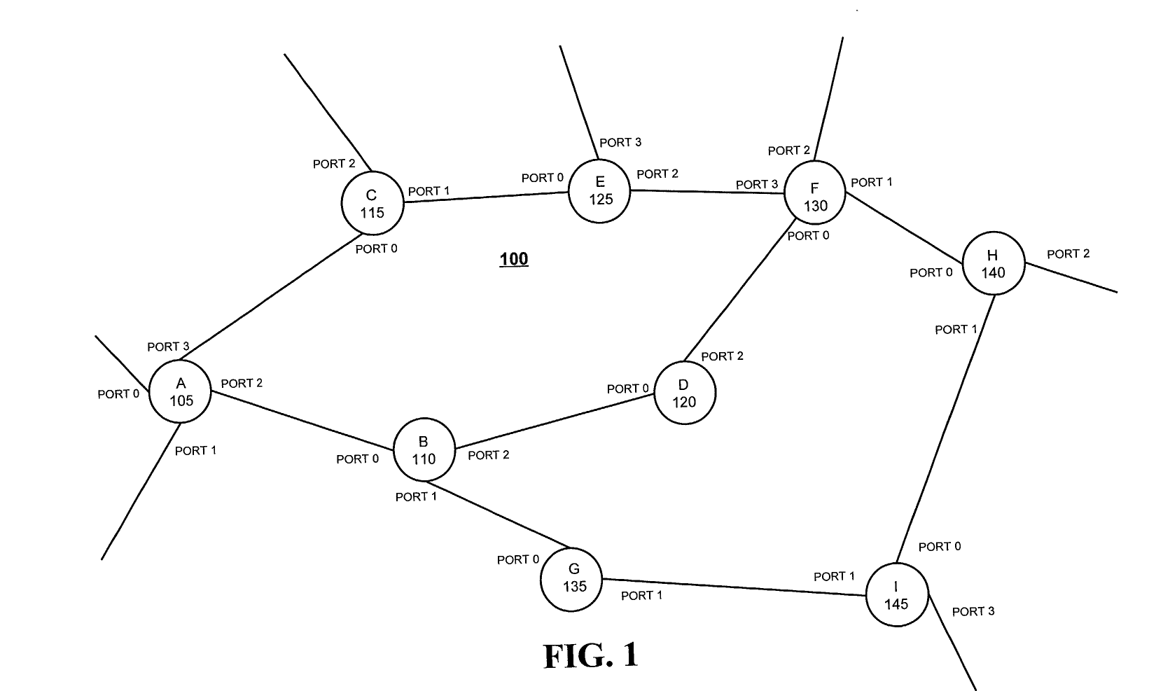

FIG. 1 illustrates an exemplary network 100 in which systems and methods, consistent with the present invention, may be implemented. Network 100 may include multiple routers plus packet-switches, each switch interconnected with another switch by conventional links. For purposes of illustration, FIG. 1 shows router/switches A 105, B 110, C 115, D 120, E 125, F 130, G 135, H 140 and I 145 interconnected by links. One skilled in the art will recognize that a typical network may include fewer or greater numbers of routers than those shown in FIG. 1.

### EXEMPLARY ROUTER/SWITCH

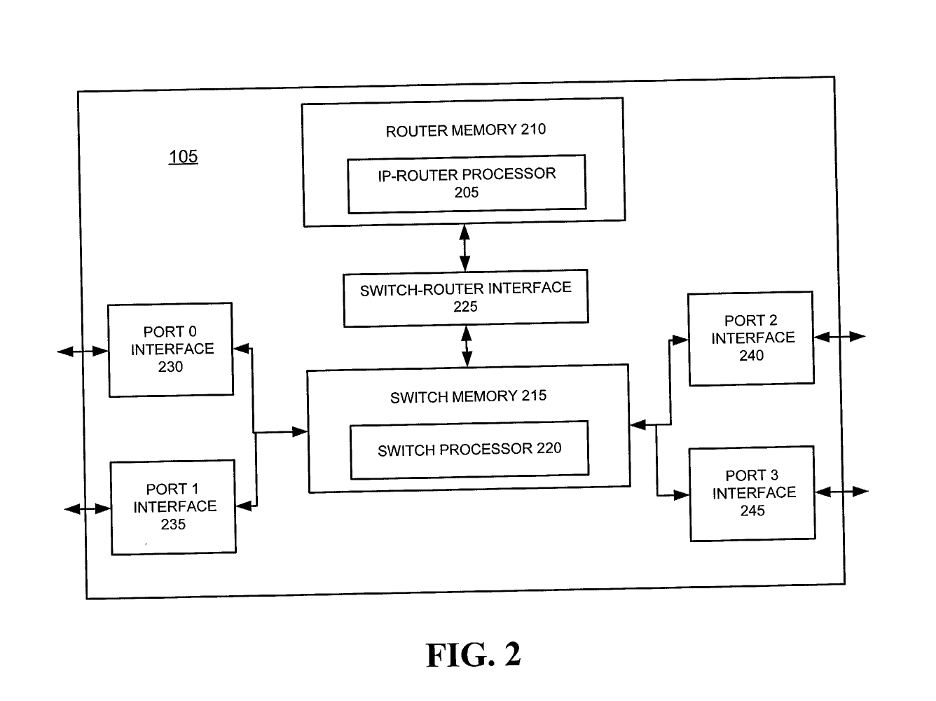

FIG. 2 illustrates an exemplary router A 105 that may route IP packets in a manner consistent with the present invention. Routers B 110-I 145 may be similarly configured. Router A 105 may include an IP-router processor 205, a router memory 210, a switch memory 215, a switch processor 220, a switch-router interface 225, and port interfaces 230, 235, 240 and 245. It will be appreciated that the router 105 may include additional components (not shown) that aid in the reception, transmission and/or processing of IP packets.

IP-router processor 205 may execute instructions for performing IP routing processes and can include a conventional processing device. Switch processor 220 may execute instructions for performing, among other functions, virtual circuit path switching and can include a conventional processing device. Router memory 210 may provide permanent, semi-permanent, or temporary working storage of data and instructions for use by IP-router processor 205. Switch memory 215 may provide permanent, semi-permanent, or temporary working storage of data and instructions for use by switch processor 220. Router memory 210 and switch memory 215 may include conventional data storage devices, such as, for example, Random Access Memory (RAM) or Dynamic RAM (DRAM).

Switch-router interface 225 may include conventional mechanisms for interfacing IP-router processor 205 with switch processor 220. Port 0 interface 230, port 1 interface 235, port 2 interface 240 and port 3 interface 245 may each include conventional mechanisms for interfacing router 105 with network 100 via a link.

### EXEMPLARY DATABASE

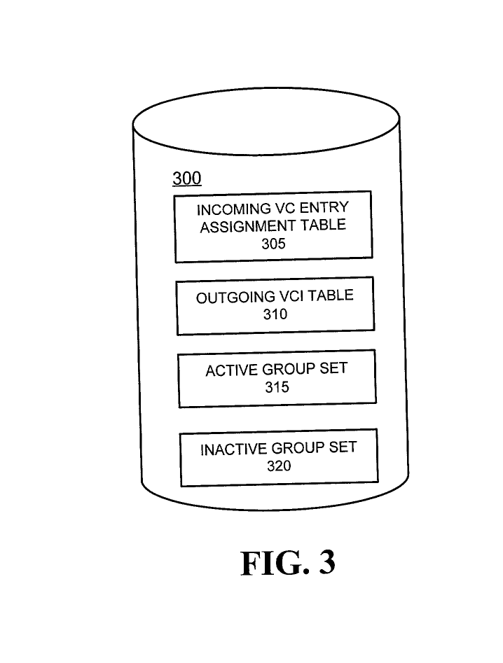

FIG. 3 illustrates an exemplary database 300, consistent with the present invention, that may be stored in switch memory 215 of router A 105. Database 300 may include an Incoming VC Entry assignment table 305, an Outgoing VCI table 310, an active group set 315, and an inactive group set 320.

Incoming VC entry assignment table 305 may include assignments of switch VC Table entries for other routers in the network. Outgoing VCI table 310 may store output ports of router A 105, and, for each port, VCIs communicated by the neighboring router connected to that port taken from the neighbor's Incoming VC entry assignment table 305. Active group set 315 may include identifiers of routers connected directly or indirectly to router A 105 for which router A 105 has added entries to its Incoming VC entry table 305. Inactive subset 320 may include identifiers of routers for which router A 105 has added entries to its Incoming VC entry table 305 but which are not currently reachable (e.g., because a network link is down or because the router has temporarily detached from the network while changing location).

### EXEMPLARY ROUTER VC TABLE

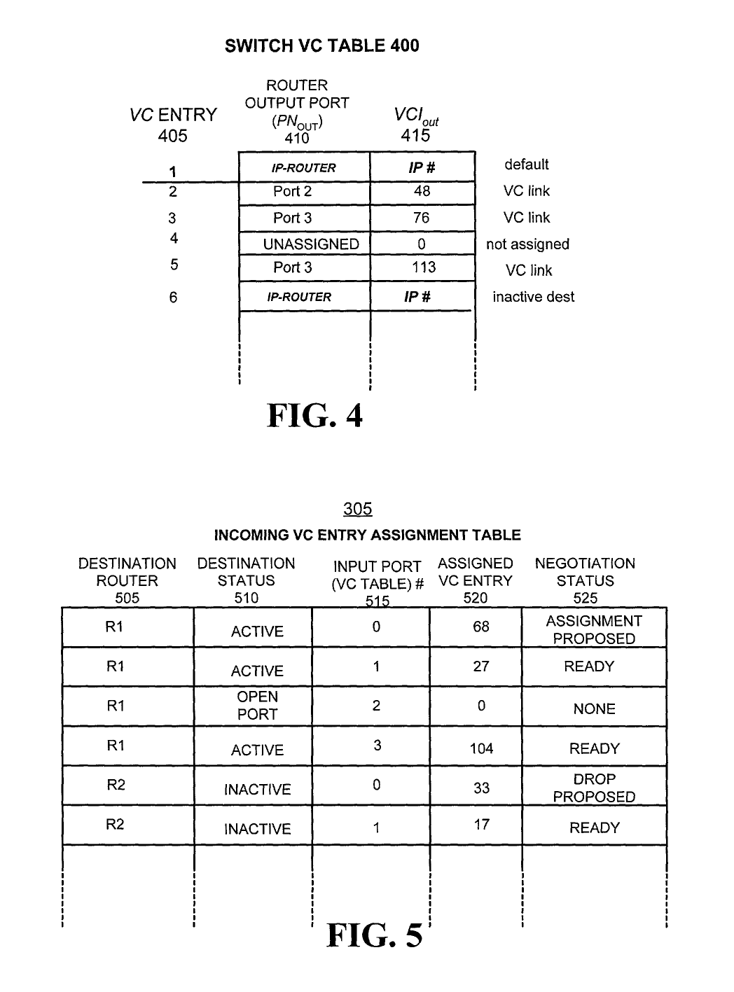

FIG. 4 illustrates an exemplary switch VC table 400, consistent with the present invention, that may be stored in switch memory 215 of a router/switch in network 100, such as router/switch A 105. Switch VC table 400 may include VC entries 405 containing router output port numbers 410 (PNₒᵤₜ) and outgoing VCI numbers 415 (VCIₒᵤₜ). VC entries 405 may correspond to incoming VCIs in the headers of received packets. Router output port numbers 410 may indicate the router output port through which to forward received packets. VCIₒᵤₜ numbers 415 may be outgoing identifiers to be placed in the packet header of each forwarded packet. One entry 405, e.g., entry one, may be the default entry conventionally provided in all VC tables 400 of all switches in network 100, such as switch A 105, for switching incoming IP packets to router A 105 for processing and/or rerouting. The output port 410 of this default entry may be the switch-router-interface 225 (IP-Router), and the VCIₒᵤₜ may be the number associated with IP packets (IP #) being delivered to the router (as distinguished, e.g., from ‘hello’ packets or tag packets).

### EXEMPLARY INCOMING VC ENTRY ASSIGNMENT TABLE

FIG. 5 illustrates an exemplary Incoming VC Entry Assignment table 305, consistent with the present invention, that may be stored in router memory 210 of a router in network 100, such as router A 105. Incoming VC Entry Assignment table 305 may include destination router entries 505, destination status entries 510, input port entries 515, assignment VC entries 520 and negotiation status entries 525. Destination router entries 505 may include identifiers for all other routers in the network 100 for which the router has assigned VC Table entries in its switch memory 215. These other routers may be in the routers active group set 315, or inactive group set 320 (the set of routers that were once active, and for which VC Table entries have been assigned, but are now unreachable). The Incoming VC Entry Assignment table 305 may have, for each entered router, a separate entry for each port interface 230-245, since switch A 105 has a separate VC Table for each input port. Input Port entries 515 may designate a port number associated with a port interface 230-245 and with a VC Table in switch memory 215. Destination status entries 510 may include an indication of which ports 230-245 are open (as opposed to connected to another switch), or may have an indication of whether an entered router is in the active group set 315 or the inactive group set 320. Assignment VC entries 520 may, together with the input port 515, uniquely identify an entry 405 of a VC Table 400. Negotiation status entries 525 may include details of negotiations with adjacent routers to coordinate the information in router A 105's Incoming VC Entry Assignment table 305 with the neighbor's Outgoing VCI table 310.

### EXEMPLARY OUTGOING VCI TABLE

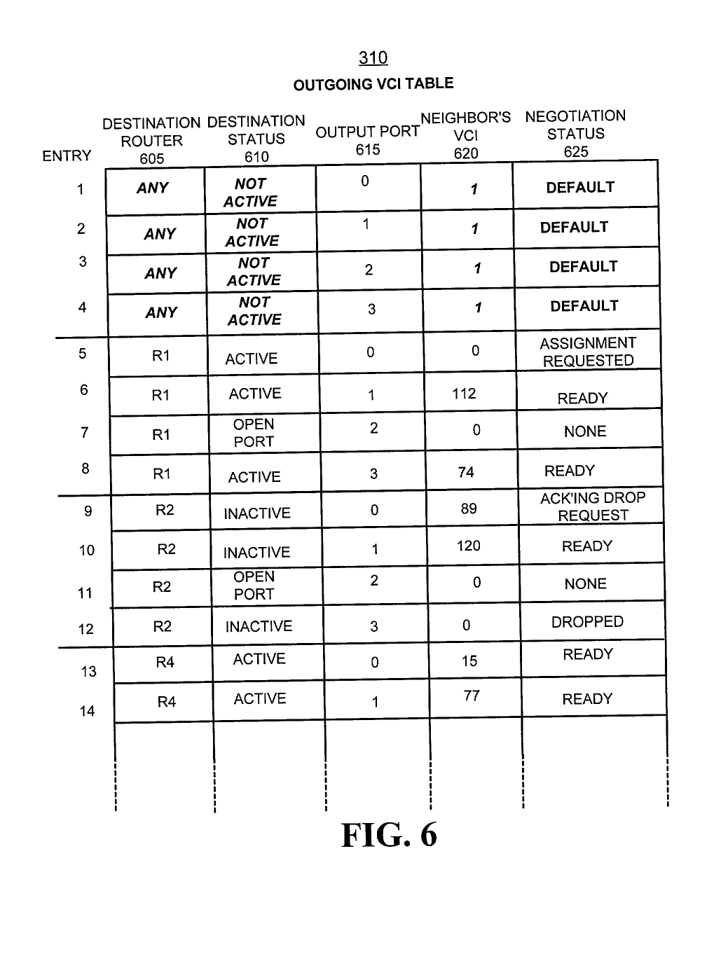

FIG. 6 illustrates an exemplary Outgoing VCI table 310, consistent with the present invention, that may be stored in router memory 210 of a router in network 100, such as router A 105. Outgoing VCI table 310 may include destination router entries 605, destination status entries 610, output port entries 615, neighbor's VCI entries 620 and negotiation status entries 625. Destination router entries 605 may include other routers in the network 100 for which an adjacent router has assigned VC Table 400 entries and Incoming VC Entry Assignment table 305 entries. In the first four rows (one per port) of the Outgoing VCI table 310, the destination router entry may be a globally understood value (ANY) that indicates that this row can be used for any router in the network 100 for which there is no entry in the table 310. Destination status entries may include an indication of which ports 230-245 are open (as opposed to connected to another switch), or may have an indication of whether an entered router is in the active group set 315 or the inactive group set 320. In the first four entries of the table 310, destination status entries are not meaningful. The Output port entries may designate a port number associated with a port interface 230-245. Each distinct destination router 605 value may appear in a separate entry for each output port 615. Neighbor's VCI entries 620 may be numbers assigned by the adjacent routers linked to output ports 615. In the first four entries of the table 310, the Neighbor's VCI entries 620 may all be the default entry, e.g., entry one, conventionally provided in all VC tables 400 of all switches in network 100, such as switch A 105, for switching incoming IP packets to router A 105 for processing and/or rerouting. Negotiation status entries 625 may include details of negotiations with adjacent routers to coordinate the information in router A 105's Outgoing VCI table 310 with the neighbor's Incoming VC Entry Assignment table 305.

### EXEMPLARY IP FORWARDING TABLE

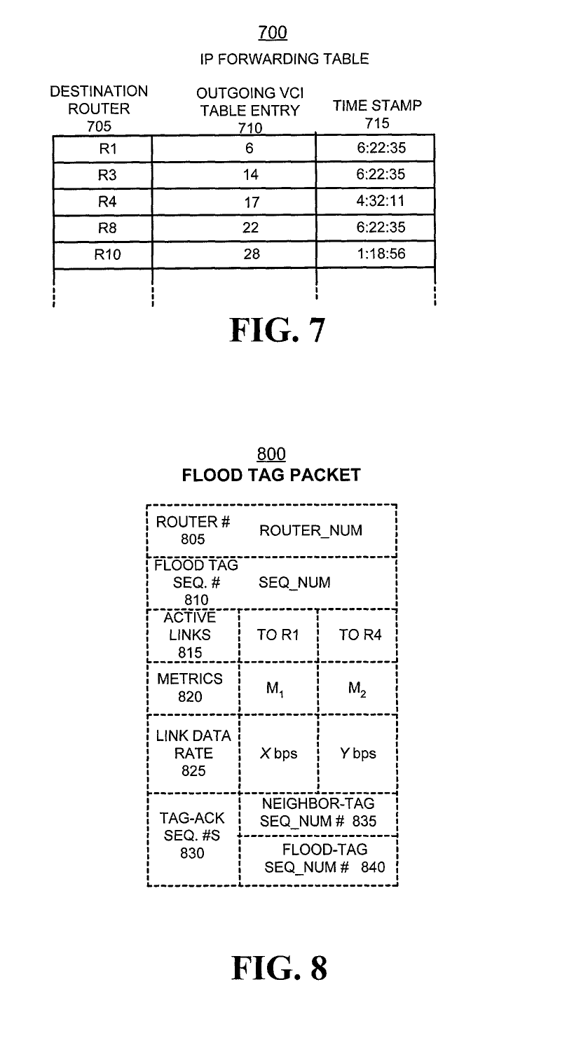

FIG. 7 illustrates an exemplary IP forwarding table 700, consistent with the present invention, that may be stored in router memory 210 of a router, such as router A 105. IP Forwarding table 700 may include Destination node entries 705, Outgoing VCI table entries 710 and Time stamp entries 715. Destination node entries 705 may be added for routers in network 100 as router A 105 learns about them. Router A 105 may maintain a spanning tree containing the best routes to connected routers, constructed using conventional techniques. IP forwarding table 700 may relate the information about a router in router A 105's spanning tree, such as router F 130, with its Outgoing VCI table 310. From the spanning tree, router A 105 may decide which output port leads to the adjacent router, such as router B 110 or router C 115, that is ‘closer’ to router F 130 (such as port 2 linking to router B 110 or port 3 linking to router C 115). Router A 105 may set the Outgoing VCI Table Entry 710 for destination router 705-F 130 to the row number of the entry 605 for F and output port 615 (e.g., 2 or 3) in Outgoing VCI table 310. Router A 105 may set the Outgoing VCI Table Entry 710 for a destination router 705 not in its active set 315 to the row number of one of the first four rows of table 310, depending on the selected output port. Each time router A 105 updates its IP Forwarding table 700, it may update the Time stamp 715 for every router in its spanning tree. This allows router A 105 to see which routers were once reachable and how long it has been since they were last reachable. This could be used in a decision to delete routers from Outgoing VCI table 310 (after negotiations with immediate neighbor routers).

### EXEMPLARY FLOOD TAG PACKET

FIG. 8 illustrates an exemplary flood-tag packet 800, consistent with the present invention, that may be used by routers in network 100, such as router A 105, for flooding link state information, and other information, to other routers in network 100. Flood packet 800 may include a router number 805, a flood tag sequence number 810, active link data 815, link metric data 820, link data rate data 825, a tag-acknowledgement sequence number 830, a neighbor-tag sequence number 835, and a flood-tag sequence number 840.

Router number 805 can identify the router sending the flood packet 800. Flood tag sequence number 810 may provide an indication of the version of packet 800 sent from the router identified by router number 805. For example, older versions of a flood tag packet sent from router A 105 may have lower sequence numbers than newer versions of the flood tag packet. Active link data 815 can identify the routers directly connected to the router identified by router number 805. Link metric data 820 can indicate the metrics for each link (e.g., latency) for the routers connected to the router identified by router number 805. Link data rate data 825 may indicate the data rate (e.g., bits/second) of each link identified by active link data 815. Tag acknowledgement sequence numbers 830 may provide an indication of the version of tag acknowledgement sent to the router identified by router number 805. For example, older versions of a tag acknowledgement sent from router A 105 may have lower sequence numbers than newer versions of the tag acknowledgement. Neighbor-tag sequence number data 835 may provide an indication of the version of the last received Neighbor-tag packet sent to router A by the immediate neighbor that has forwarded the flood-tag packet 800, which may serve to acknowledge the Neighbor-tag packet. Flood-tag sequence number 840 may provide an indication of the version of the last received Flood-tag packet sent to router A by the immediate neighbor that has forwarded the flood-tag packet 800, which may serve to acknowledge the Flood-tag packet.

### EXEMPLARY NEIGHBOR-TAG PACKET

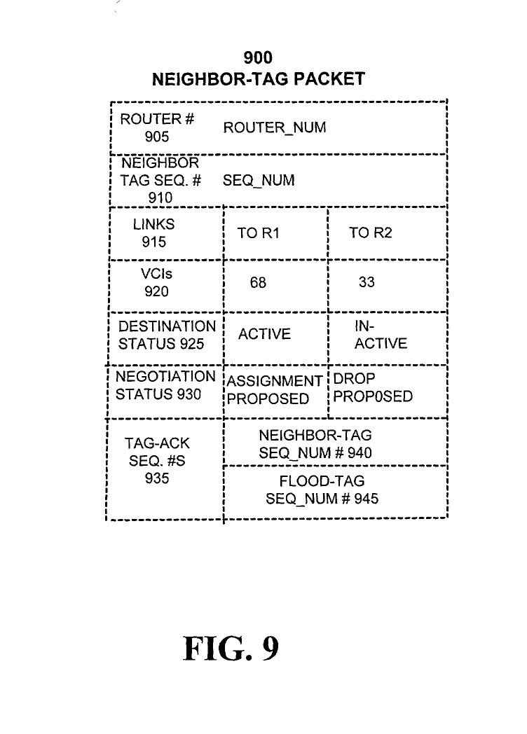

FIG. 9 illustrates an exemplary neighbor-tag packet 900, consistent with the present invention, that may be used by routers in network 100, such as router 105, for forwarding virtual circuit and negotiation status information to neighboring routers in network 100. Neighbor-tag packet 900 may include a router number 905, a neighbor-tag sequence number 910, link data 915, VCI data 920, destination status data 925, negotiation status data 930, tag-acknowledgement sequence numbers 935, neighbor-tag sequence number data 940, and flood-tag sequence number 945.

Router number 905 can identify the adjacent router sending the neighbor-tag packet 900. Neighbor-tag sequence number 910 may provide an indication of the version of packet 900 sent from the adjacent router identified by router number 905. For example, older versions of a neighbor-tag packet sent from router A 105 may have lower sequence numbers than newer versions of the neighbor-tag packet. Link data 915 can indicate the routers in the active group set 315 of the adjacent router identified by router number 905. VCI data 920 includes virtual circuit identifiers for virtual circuits to routers within network 100, as specified in the Incoming VC Entry Assignment table 305 of the adjacent router identified by router number 905. Destination status data 925 can include an indication of whether a router identified by Link data 915 is currently in the active group set 315 or in the inactive group set 320 of the adjacent router identified by router number 905.

Negotiation status 930 can include details of negotiations with router A 105 to coordinate the information in router A 105's Outgoing VCI table 310 with the Incoming VC Entry Assignment table 305 of the adjacent router identified by router number 905. Tag acknowledgement sequence numbers 935 may provide an indication of the version of the tag acknowledgement sent to the router identified by router number 905. For example, older versions of a tag acknowledgement sent from router A 105 may have lower sequence numbers than newer versions of the tag acknowledgement. Neighbor-tag sequence number data 940 may provide an indication of the version of the last received Neighbor-tag packet sent to router A by the adjacent router identified by router number 905, which may serve to acknowledge the Neighbor-tag packet. Flood-tag sequence number 945 may provide an indication of the version of the last received Flood-tag packet forwarded to router A by adjacent router identified by router number 905, which may serve to acknowledge the Flood-tag packet. EXEMPLARY FLOOD-TAG PROCESSING

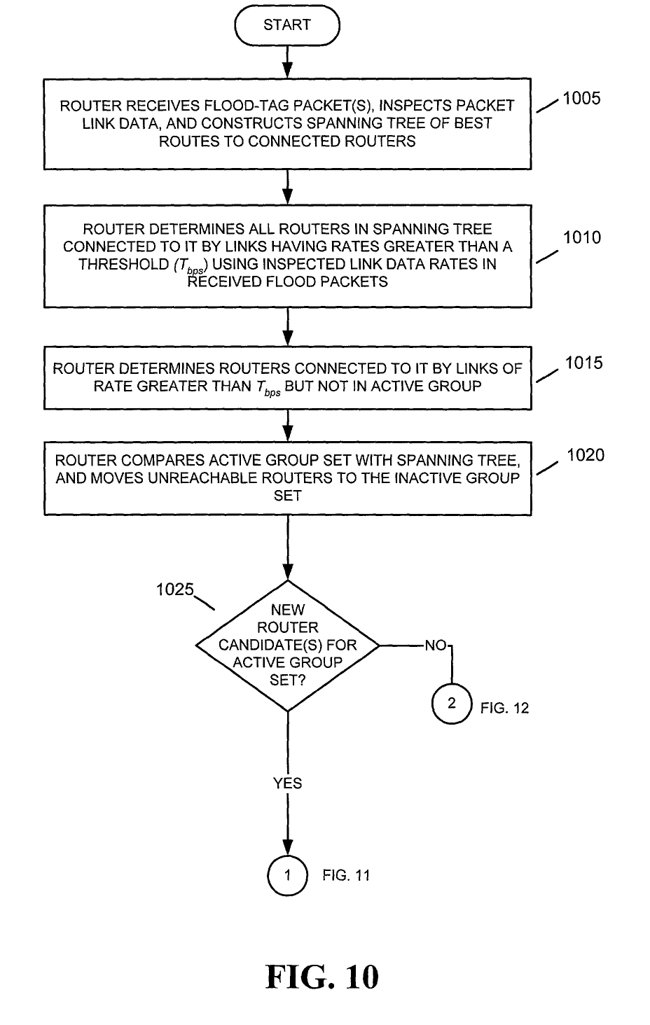

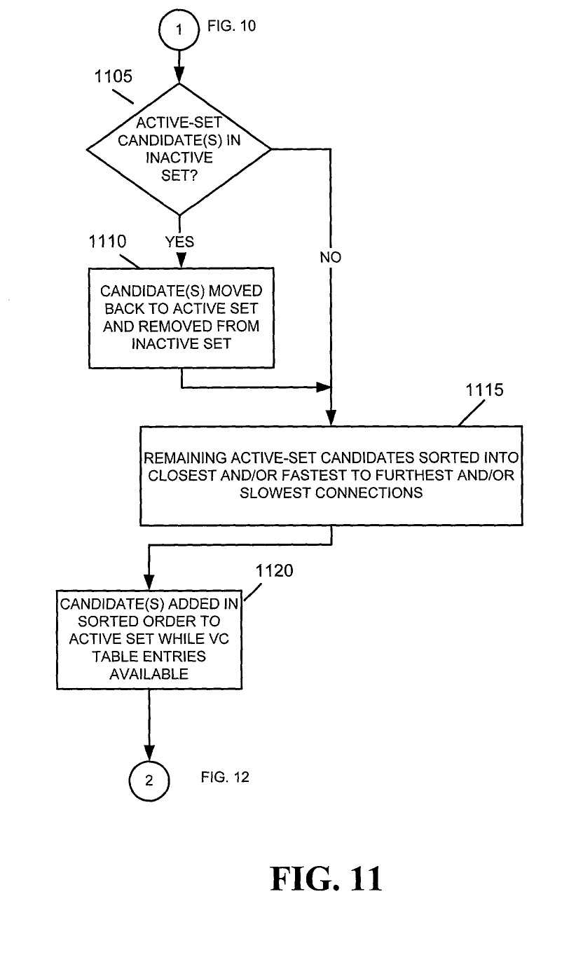

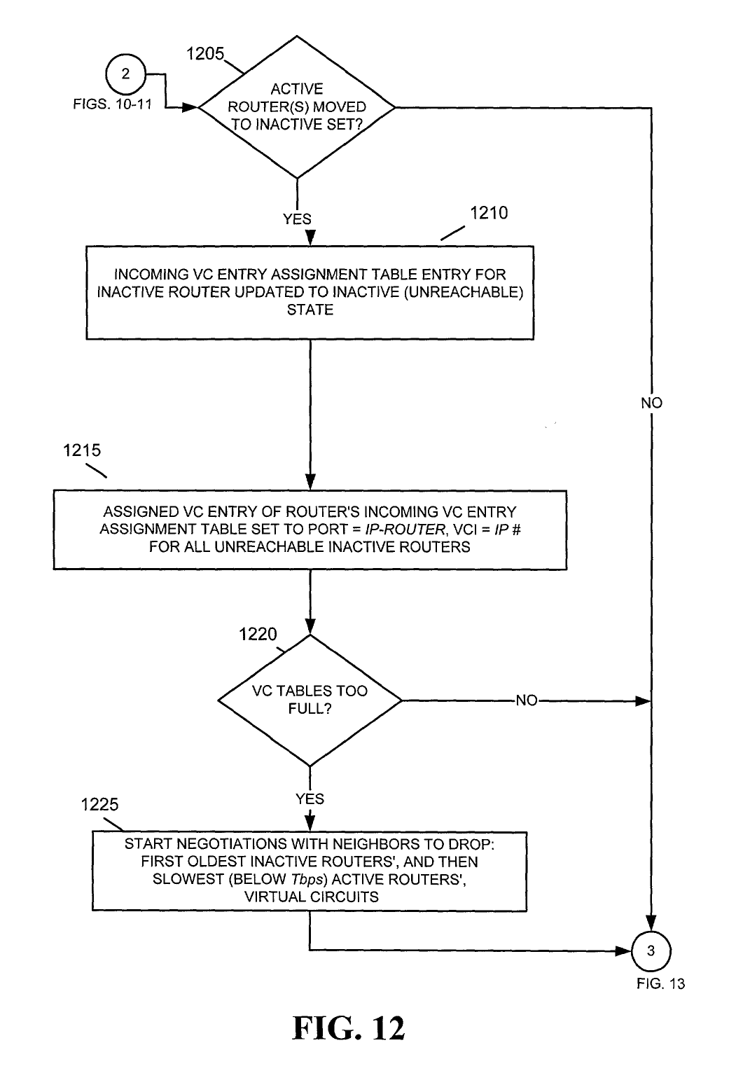

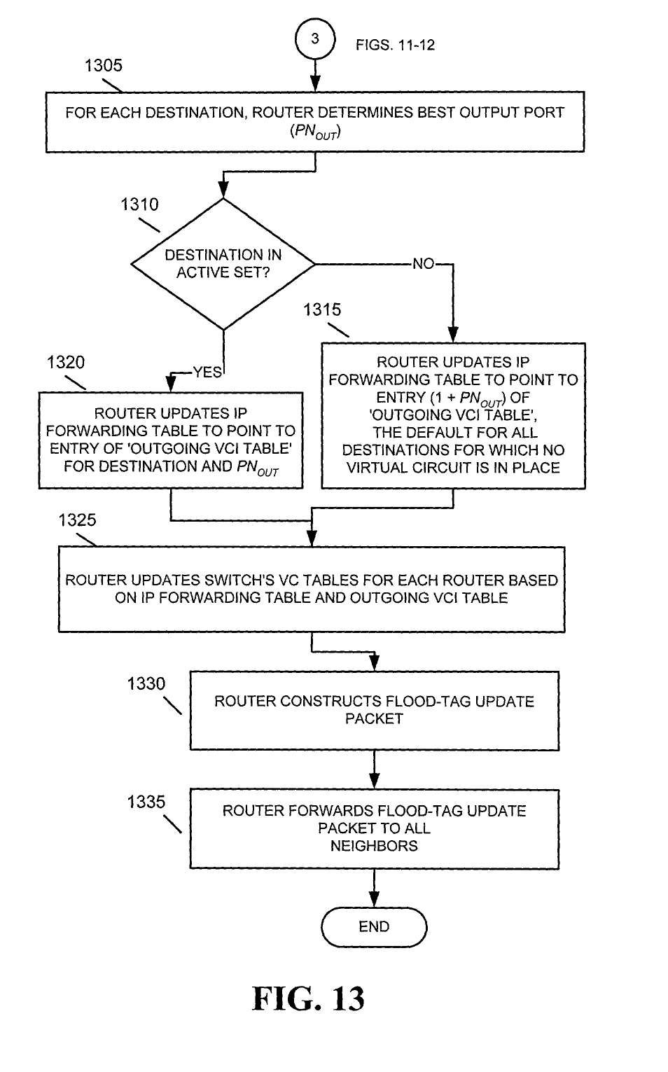

FIGS. 10-13 are flowcharts that illustrate exemplary processing, consistent with the present invention, for using link data from received flood-tag packets 800 to determine an active group set 315 for assigning VCIs at a router in network 100. As one skilled in the art will appreciate, the method exemplified by FIGS. 10-13 can be implemented as a sequence of instructions and stored in switch memory 215 of a router in network 100, such as router A 105.

To begin processing, router A 105 may receive flood-tag packet(s) 800 from neighboring routers and then may inspect the active links 815, the link metrics 820, and link data rates 825 in each received flood-tag packet 800, and construct a spanning tree containing the best routes to connected routers using conventional techniques [step 1005]. For example, router A 105 may conclude at one time that the best path to router F 130 is through routers B 110 and D 120, and may conclude at another time that the best route to router F 130 is through routers C 115 and E 125. Using the link data rates 825 from each received flood-tag packet 800, router A 105 may further determine all routers in the constructed spanning tree that are connected to it by links having rates greater than a threshold data rate (T_{bps}) [step 1010]. Router A 105 may determine routers connected to it by links of rates greater than T_{bps}, but that are not currently in active group set 315 [step 1015]. For example, router I 145 may become reachable as it attaches to routers G 135 and H 140, and the end-to-end data rate between router A 105 and router I 145 may be high enough to justify allocating a virtual circuit from A to I. Router A 105 can also compare the active group set 315 with the constructed spanning tree and move routers that have become unreachable to the inactive group set 320 [step 1020].

If Router A 105 determines, from step 1015, that there are no new router candidates for active group set 315 [step 1025], processing continues at step 1205 (FIG. 12). If there is, such as router I 145, router A 105 determines if the candidate for the active group set 315 is in the inactive group set 320 [step 1 105]. If so, router A 105 moves the candidate back to the active group set 315 and removes the candidate from the inactive group set 320 [step 1110]. For example, router I 145 may have once been active while connected to router B 110, then become inactive when it disconnected from B before driving to where it could connect to both routers G 135 and H 140. Upon connecting in its new location, router I 145 may be moved back from inactive to active. If there are candidates for the active group set 315 not in the inactive group set 320, router A 105 may sort these active group set 315 candidates into closest and/or fastest to furthest and/or slowest connections using the constructed spanning tree and the link data 815-825 from the received flood-tag packets 800 [step 1115]. Router A 105 may then add the router candidates in sorted order to active group set 315 while VC table entries are available [step 1120]. For example, if router 1145 is connected to a more distant router through port 3 (not shown in network 100), router 1145 could be added to the active list before the more distant router in case adding router 1145 were to fill the VC tables in switch memory 215, thus blocking the addition of the more distant router.

At step 1205, router A 105 determines if any onced-active routers have been moved to the inactive group set 320 because they are no longer reachable. If not, processing continues at step 1305 (FIG. 13). If so, router A 105 can update the Incoming VC Entry Assignment table 305 destination status entry 610 to an inactive (i.e., unreachable) state [step 1210]. Router A 105 may then set the assigned VC table entry 405 of switch A 105's VC table specified by router A 105's Incoming VC Entry Assignment table 305 to port—“IP-router” and VCI=IP # for all unreachable inactive routers [step 1215]. For example, if router I 145 were to disconnect from the network in preparation for moving to a new location, router A 105 would want to intercept any packets sent toward router I 145 by router C 115 using the VCI that router A 105 had previously proposed to router C 115 in a neighbor-tag packet 900. If this VCI were listed in entry 16, for example, of router A 105's Incoming VC Entry Assignment table 305, then the input port number 515 in entry 16 (port 3 as indicated in FIG. 1) facing router C 115 specifies the VC table 400 in switch memory 215 to modify, and assigned VC entry 520 in row 16 indicates which entry of this VC table to change.

Router A 105 may determine if its switch's VC Tables 400 are too full (i.e., insufficient remaining free entries) [step 1220]. If not, processing continues at step 1305 (FIG. 13). If tables 400 are too full, then router A 105 starts negotiations with adjacent routers to drop the oldest inactive routers and then the slowest (e.g., connecting links below T_{bps}) active routers and the corresponding virtual circuits [step 1225]. For example, if considerable time passes and router I 145 does not reconnect anywhere that router A 105 can reach in the network, then eventually router A 105 may negotiate with its neighbors (using neighbor-tag packets 900) to free up the rows (one per port) of both its Incoming VC Entry Assignment table 305 and Outgoing VCI table 310.

Router A 105 may determine for each destination, using conventional techniques and based on a new spanning tree constructed by conventional techniques, the output port (PNₒᵤₜ ) facing the ‘best’ path to the destination [step 1305]. Router A 105 may then determine if a destination router is in active group set 315 [step 1310]. If not, router A 105 sets the entry in IP Forwarding table 700 for the destination to the correct default for PNₒᵤ for destinations for which no virtual circuit is in place [step 1315]. If a destination router is in active group set 315, router A 105 sets the entry in IP Forwarding table 700 for this destination to the correct entry for and this destination [step 1320]. Then using IP Forwarding table 700 and Outgoing VCI table 310, router A 105 makes sure that all VC Table entries are current and correctly set. For example, if router A 105 were to decide that the best path to router F 130 were through router C 115 instead of router B 110, and if router F is in active group set 305, then the PNout for router F 130 would change from 2 to 3 (according to FIG. 1) and the IP Forwarding table entry for F 130 would change to the row of Outgoing VCI table 310 listing router F and port 3 from the row above listing port 2, and the entries for router F 130 in the switch VC tables for all ports would be updated to point to port 3 and use the VCIout indicated in this new row of Outgoing VCI table 310 [step 1325].

At step 1330, router A 105 may construct a flood-tag update packet 800. Router A 105 may then forward the constructed flood-tag update packet 800 to all neighboring routers [step 1335].

### EXEMPLARY NEIGHBOR-TAG PACKET PROCESSING

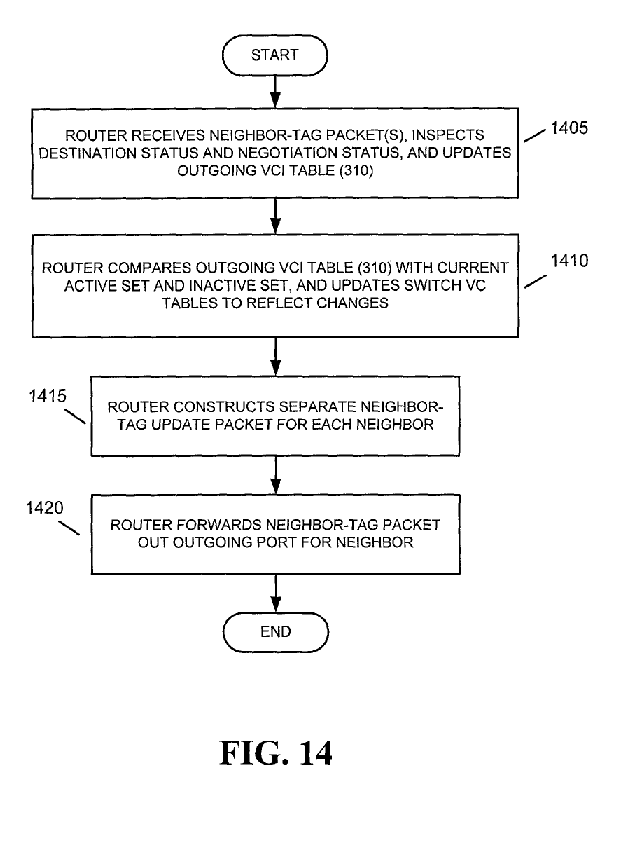

FIG. 14 is a flowchart that illustrates exemplary processing, consistent with the present invention, for receiving and constructing neighbor-tag packets 900 at a router in network 100, such as router A 105. As one skilled in the art will appreciate, the method exemplified by FIG. 14 can be implemented as a sequence of instructions and stored in switch memory 215 of router A 105.

To begin processing, router A 105 may receive neighbor-tag packet(s) 900 and then may inspect destination status data 925 and negotiation status data 930, and update the outgoing VCI table 310 [step 1405]. For example, router A 105 may be in the process of negotiating VCIout values for a newly attached router I 145 with its neighbors. Router A 105 may then compare the outgoing VCI table 310 with the current active group set 315 and inactive group set 320 and update its Switch VC Tables 400 for any changes needed [step 1410]. For example, VC table 400 entries will be set to the default entries IP-Router and IP # for all unreachable, hence inactive, routers. Router A 105 may then construct a separate neighbor-tag packet for each neighbor [step 1415] and forward the constructed neighbor-tag packets out an outgoing port to reach each neighbor [step 1420].

### EXEMPLARY ROUTER FORWARDING PROCESSING

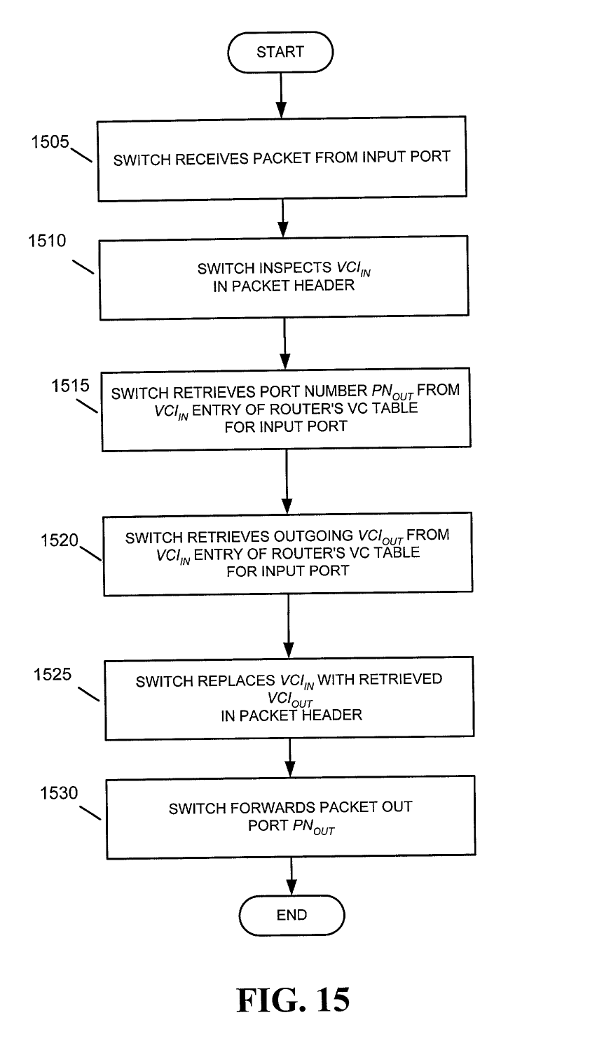

FIG. 15 is a flowchart that illustrates exemplary processing, consistent with the present invention, for forwarding packets received at a switch in network 100, such as switch A 105. As one skilled in the art will appreciate, the method exemplified by FIG. 15 can be implemented as a sequence of instructions and stored in switch memory 215 of switch A 105. To begin processing, switch A 105 may receive a packet [step 1505] and inspect the packet's incoming VCI [step 1510]. Router A 105 may then retrieve an output port number 415 from VC entry 405 of VC table 400 [step 1515]. Router A 105 may then retrieve an outgoing VCI (VCIₒᵤₜ) 415 from VC entry 405 in VC table 400 [step 1520]. Router A 105 can replace the incoming VCI from the packet with the retrieved outgoing VCI [step 1525]. Router A 105 may then forward the packet out an output port corresponding to the retrieved output port number 415 [step 1530].

### CONCLUSION

Systems and methods consistent with the present invention provide mechanisms that permit each router in the network to control the setup of its switch's virtual circuit tables according to peer-to-peer negotiations with its nearest neighbors, thus, eliminating the need for, and avoiding the rigidity and latency of, connection request messages for establishing virtual paths to other routers in the network. The result is the establishment and maintenance of dynamically changing paths between all pairs of routers for which the connection is deemed critical enough, where this determination is based partly on the link data rates and other link data of the network and partly on the capacities of the switches' virtual circuit tables.

The foregoing description of exemplary embodiments of the present invention provides illustration and description, but is not intended to be exhaustive or to limit the invention to the precise form disclosed. Modifications and variations are possible in light of the above teachings or may be acquired from practice of the invention. For example, while certain components of the invention have been described as implemented in hardware and others in software, other configurations may be possible. Also, while series of steps have been described with regard to FIGS. 10-15, the order of the steps may be altered in other implementations consistent with the present invention. No element, step, or instruction used in the description of the present application should be construed as critical or essential to the invention unless explicitly described as such. The scope of the invention is defined by the following claims and their equivalents.

What is claimed is:

1. A method of assigning virtual circuit identifiers for routing data in a network comprising a plurality of nodes interconnected by links of different data rates, the method comprising:
receiving link state information at a first node of the plurality of nodes, the link state information comprising link data rate information;
determining whether the link data rate information indicates if the links interconnecting the plurality of nodes satisfy a threshold data rate; and
assigning virtual circuit identifiers to nodes in the network based on whether the link data rate information indicates that the links satisfy the threshold data rate.

2. The method of claim 1, wherein the link state information received at the first node is received in packets flooded from at least one node of the plurality of nodes.

3. The method of claim 1, further comprising:
identifying, from the link data rate information, fastest links of the links interconnecting the plurality of nodes; and
assigning virtual circuit identifiers to nodes in the network interconnected via the fastest links.

4. A network device, comprising:
at least one network interface configured to:
connect to at least one link, the at least one link being further connected to at least one node of a plurality of nodes in a network, and
receive link state information comprising link data rate information; and at least one processor configured to:
determine whether the link data rate information indicates if the links interconnecting the plurality of nodes satisfy a threshold data rate, and
assign virtual circuit identifiers to nodes in the network based on whether the link data rate information indicates that the links satisfy the threshold data rate.

5. The network device of claim 4, wherein the link state information is received in packets flooded from at least one node of the plurality of nodes.

6. The network device of claim 4, wherein the at least one processor is further configured to:
identify, from the link data rate information, fastest links of the links interconnecting the plurality of nodes, and
assign virtual circuit identifiers to nodes in the network interconnected via the fastest links.

7. A computer-readable medium containing instructions for controlling at least one processor to perform a method of assigning virtual circuit identifiers for routing data in a network comprising a plurality of nodes interconnected by links of different data rates, the method comprising:
obtaining link data rate information by a first node of the plurality of nodes;
determining whether the link data rate information indicates if the links interconnecting the plurality of nodes satisfy a threshold data rate; and
assigning virtual circuit identifiers to nodes in the network based on whether the link data rate information indicates that the links satisfy the threshold data rate.

8. The computer-readable medium of claim 7, wherein the data rate information obtained by the first node is received in packets flooded from at least one node of the plurality of nodes.

9. The computer-readable medium of claim 7, the method further comprising:
identifying, from the link data rate information, fastest links of the links interconnecting the plurality of nodes; and
assigning virtual circuit identifiers to nodes in the network interconnected via the fastest links.

10. A method of routing data in an ad-hoc network comprising a plurality of nodes interconnected by links of different data rates, the method comprising:
receiving link state information at a first node of the plurality of nodes, the link state information comprising link data rate information;
determining whether the link data rate information indicates if the links interconnecting the plurality of nodes satisfy a threshold data rate;
assigning virtual circuit identifiers to nodes in the network based on whether the link data rate information indicates that the links satisfy the threshold data rate; and
routing data received at the first node using the assigned virtual circuit identifiers.

11. The method of claim 10, wherein the link state information received at the first node is received in packets flooded from at least one node of the plurality of nodes.

12. The method of claim 10, further comprising:
identifying, from the link data rate information, fastest links of the links interconnecting the plurality of nodes;
assigning virtual circuit identifiers to nodes in the network interconnected via the fastest links; and
routing data received at the first node using the assigned virtual circuit identifiers.

13. A router, comprising:
at least one network interface configured to:
connect to at least one link, the at least one link being further connected to at least one node of a plurality of nodes in a network; and at least one processor configured to:
receive link state information at the router the link state information comprising link data rate information,
determine whether the link data rate information indicates if the links interconnecting the plurality of nodes satisfy a threshold data rate,
assign virtual circuit identifiers to nodes in the network based on whether the link data rate information indicates that the links satisfy the threshold data rate,
route data received at the router using the assigned virtual circuit identifiers.

14. The router of claim 13, wherein the link state information is received in packets flooded from at least one node of the plurality of nodes.

15. The router of claim 13, wherein the at least one processor is further configured to:
identify, from the link data rate information, the fastest links of the links interconnecting the plurality of nodes,
assign virtual circuit identifiers to nodes in the network interconnected via the fastest links, and
route data received at the router using the assigned virtual circuit identifiers.

16. A computer-readable medium containing instructions for controlling at least one processor to perform a method of routing data in an ad-hoc network comprising a plurality of nodes interconnected by links of different data rates, the method comprising:
receiving link data rate information at a first node of the plurality of nodes;
determining whether the link data rate information indicates if the links interconnecting the plurality of nodes satisfy a threshold data rate;
assigning virtual circuit identifiers to nodes in the network based on whether the link data rate information indicates that the connected links satisfy the threshold data rate; and
routing data received at the first node using the assigned virtual circuit identifiers.

17. The computer-readable medium of claim 8, wherein the link data rate information received at the first node is received in packets flooded from at least one node of the plurality of nodes.

18. The computer-readable medium of claim 8, wherein the at least one processor is further configured to:
identify, from the link data rate information, fastest links of the links interconnecting the plurality of nodes,
assign virtual circuit identifiers to nodes in the network interconnected via the fastest links, and
route data received at the first node using the assigned virtual circuit identifiers.

19. A system for routing data in an ad-hoc network comprising a plurality of nodes interconnected by links of different data rates, the system comprising:
means for receiving link state information at a first node of the plurality of nodes, the link state information comprising link data rate information;
means for determining whether the link data rate information indicates if the links interconnecting the plurality of nodes satisfy a threshold data rate;
means for assigning virtual circuit identifiers to nodes in the network based on whether the link data rate information indicates that the links satisfy the threshold data rate; and
means for routing data received at the first node using the assigned virtual circuit identifiers.
